(19) United States
(12) Patent Application Publication
(10) Pub. No.: US 2008/0107894 A1
(43) Pub. Date: May 8, 2008

(54) Polysilazane-Based Coating Solution And The Use Thereof For Coating Films, Especially Polymer Films

(76) Inventors: Stefan Brand, Hirschberg-Leutershausen (DE); Andreas Dierdorf, Hofheim (DE); Hubert Liebe, Wiesbaden (DE); Andreas Wacker, Mannheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/791,550

(22) PCT Filed: Oct. 25, 2005
(86) PCT No.: PCT/EP05/11425

§ 371 Date: May 23, 2007

(30) Foreign Application Priority Data
Nov. 23, 2004 (DE) 10-2004056394.2

(51) Int. Cl. C08G 77/26; B05D 3/06; B32B 27/32; B32B 27/36; B32B 27/34; C08G 77/08

(52) U.S. Cl. 428/336; 427/542; 528/38; 528/21; 528/14; 428/446; 428/451

(57) ABSTRACT

A coating for coating films, which comprises, dissolved in a solvent, polysilazane or a mixture of polysilazanes of the general formula

—(SiR′R″—NR′″)ₙ—

wherein R′, R″, R″′ are the same or different and independently represent hydrogen or an optionally substituted alkyl, aryl or (trialkoxysilyl)alkyl group, where n is an integer and is selected in such a manner that the polysilazane has a number-average molecular weight of from 150 to 150 000 g/mol, and at least one catalyst. The invention also relates to a method for coating films, especially polymer films, to coated films and to film composites.

The present invention relates to a polysilazane-based coating and to the use thereof for continuously coating films, especially polymer films, and to a process for continuously coating films with polysilazanes.

Films made of polymers play an important role in many fields of industry, and for objects for daily use.

According to the application, ever higher demands are being made on the properties of the films. In the field of packaging materials, these are, for example, a barrier action against oxygen, carbon dioxide or water. In industrial films, for example, a higher scratch resistance, chemical resistance or a UV protective action are required.

Demands for a barrier action are made in particular in the field of packaging materials. The state of the art is represented by various processes for improving the insufficient barrier action of the pure polymers.

In the production of what are known as film composites, a plurality of films of which at least one consists of a material having an increased barrier action are combined by coextrusion or lamination.

One example of a film material having an increased barrier action against oxygen is EVOH. However, this polymer has the disadvantage that the barrier action of the polymer film is moisture-dependent and decreases greatly at high atmospheric moisture contents.

It is possible by vacuum deposition to apply barrier layers to polymer films. These may be metallic layers, for example aluminum, or oxidic layers such as Al₂O₃ or SiOₓ. Films coated with aluminum by deposition have the disadvantage that they are not transparent. The production of transparent coatings such as SiOₓ by means of the chemical vapor deposition (CVD) process is very complicated and is therefore associated with huge apparatus complexity and financial outlay. Furthermore, the nonstoichiometric SiOₓ layers can have yellow coloration which is undesired.

The literature discloses that polysilazanes can increase the barrier action on polymers, but the only processes for coating and curing which are known to date are those in which the polysilazane-coated polymers have to be treated over a prolonged period at elevated temperature or moisture content or with certain chemicals, so that they are unsuitable for a continuous, economically viable process for film coating.

U.S. Pat. No. 5,747,623 describes the preparation of ceramic layers of polysilazanes. Examples 20 and 21 also mention the coating of PET films with perhydropolysilazane. The coating is cured by heating to 150° C. for one hour, followed by treatment in dilute hydrochloric acid or at 95° C. and 80% relative atmospheric humidity for 3 hours. Both methods are unsuitable for an industrial process for coating polymer films.

JP-81 74 763 describes a packaging material which is provided with a protective layer of perhydropolysilazane. There is no precise specification of the polysilazane solution nor whether it comprises a catalyst. The coating is cured by drying and subsequent calcining in an oxidative atmosphere. There are no details in the examples-of the precise conditions which are required for the curing.

JP-1 00 16 150 describes the use of a polysilazane for obtaining a barrier layer on a polymer film. In the example described, the polysilazane is conditioned within a period of 150 h at a temperature of 60-70″C. This process is thus unsuitable for use on the industrial scale for film coatings.

JP-93 00 522 describes the use of a polysilazane for producing a barrier layer on a biodegradable polymer. Example 20 describes the application of the polysilazane. The curing is effected in a two-stage process, first at 120° C. within 1 h, followed by a conditioning step at 80° C. and 90% relative atmospheric moisture within 2 h. This process too does not constitute an economically viable coating process for industrial film coating.

EP-781 815 A1 describes processes for producing a ceramic coating starting from polysilazanes. Examples 27 to 59 also describe the continuous coating of polymer films. In these examples, various methods are described for conditioning the coating, which consist of a combination of two of a total of four possible steps.

One conditioning step is the passage through a drying zone at elevated temperature, which additionally contains water vapor. Alternatively, the drying zone, instead of water vapor, may also contain various gaseous chemicals (hydrogen peroxide, hydrogen chloride, acetic acid or amines). A third possible step is the passage through an immersion bath (filled with water, inorganic or organic acids, sodium hydroxide solution, amines or hydrogen peroxide). Finally, the storage of the coated film under defined climatic conditions over a prolonged period is a step for conditioning.

The methods described for conditioning the polysilazane coating are firstly very time-consuming, since the individual steps require between a few minutes and several hours and are thus not cost-effective for an industrial continuous coating process. In addition, the treatment of the film with controversial chemicals which have to be applied in a complicated process is problematic. Such processes entail high apparatus complexity, in which the problems of recycling and of disposing of the chemicals used additionally arise; in addition, excess chemicals have to be washed off the polymer film, which necessitates an additional working step. A common feature of all of these processes is that, although it is possible to apply barrier layers to polymer materials with polysilazanes, the curing of the coating entails such long process times or is technically so complicated that they are unsuitable for an industrial process which requires a high throughput in order to be economically viable.

It is thus an object of the present invention to develop a coating for films, in particular for polysilazane-based polymer films, with which particular performance-relevant properties of the films can be improved and which can additionally be applied inexpensively and rapidly to the film in a continuous coating process.

It has now been found that, surprisingly, polysilazane-based coatings can be applied to films and conditioned in a continuous coating process which includes only a short drying step within short processing times, and simultaneously improves certain performance properties in films, especially polymer films, such as barrier action, chemical resistance, UV absorption or scratch resistance.

The invention therefore provides a coating for films, comprising a solution of a polysilazane or a mixture of polysilazanes of the formula 1

—(SiR′R″—NR′″)ₙ— (1)

where R′, R″, R″′ are the same or different and are each independently hydrogen or an optionally substituted alkyl, aryl or (trialkoxysilyl)alkyl radical, where n is an integer which is such that the polysilazane has a number-average molecular weight of from 150 to 150 000 g/mol, in a solvent and at least one catalyst. Particularly suitable polysilazanes are those in which R′, R″, R″ are each independently a radical from the group of hydrogen, methyl, ethyl, propyl, isopropyl, butyl, isobutyl, tert-butyl, phenyl, vinyl or 3-(triethoxysilyl)propyl, 3-(trimethoxy-silyl)propyl. In a preferred embodiment, perhydropolysilazanes of the formula 2 are used for the inventive coating.

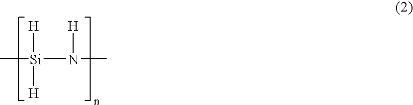

In a further preferred embodiment, the inventive coating comprises polysilazanes of the formula (3)

—(SiR′R″—NR′″)ₙ—(SiR*R**—NR***)ₚ— (3)

where R′, R″, R″′, R*, R** and R*** are each independently hydrogen or an optionally substituted alkyl, aryl, vinyl or (trialkoxysilyl)alkyl radical where n and p are each an integer and n is such that the polysilazane has a number-average molecular weight of from 150 to 150 000 g/mol.

Especially preferred are compounds in which
R′, R″′ and R*** are each hydrogen, and R″, R* and R** are each methyl;
R′, R″′ and R*** are each hydrogen, and R″, R* are each methyl, and R** is vinyl; or
R′, R″′, R* and R*** are each hydrogen, and R″ and R** are each methyl.

Preference is likewise given to polysilazanes of the formula (4)

—(SiR′R″—NR″′)ₙ-(SiR*R**—NR***)ₚ—(SiR¹, R²—NR³)_{q}— (4)

where R′, R″, R″′, R*, R**, R***, R¹, R² and R³ are each independently hydrogen or an optionally substituted alkyl, aryl, vinyl or (trialkoxysilyl)alkyl radical, where n, p and q are each an integer and n is such that the polysilazane has a number-average molecular weight of from 150 to 150 000 g/mol.

Especially preferred are compounds in which
R′, R″′ and R*** are each hydrogen, and R″, R*, R** and R² are each methyl, R³ is (triethoxysilyl)propyl and R¹ is alkyl or hydrogen.

The invention further provides a process in which films are coated continuously with a polysilazane solution. The polysilazane solution can be applied to the polymer film, for example, by roll application, dipping or spraying.

Finally, the invention provides the polymer films coated in accordance with the invention.

Polysilazanes are cured in the continuous film coating process either by passage through an oven or passage of a drying zone which is equipped with IR or NIR radiators. These radiators work in the wavelength range from 12 to 1.2 micrometers and from 1.2 to 0.8 micrometers respectively. The radiation intensities are preferably in the range from 5 to 1 000 kW/m². The temperature, the residence time in the oven and the radiation intensity of the IR or NIR radiators are adjusted in such a way that there is no excessive heating and thus damage to the thermally sensitive polymer material.

Polysilazanes exhibit very good adhesion to a wide variety of substrates, even to polymeric organic materials. Suitable polymer films may, for example, consist of polyolefins such as polyethylene, polypropylene, polyesters such as polyethylene terephthalate (PET), polyethylene naphthalate (PEN), polyamides, PVC, polycarbonate, PMMA or of copolymers of the polymer materials mentioned.

It is also possible that the polymer film already has a thin SiOx layer which has been applied by means of a preceding process, without there being impairment of the adhesion.

The polysilazane solution is applied in a continuous process, i.e. the application to the film is effected, for example, by means of roll application, immersion or by spraying. The application may be effected either on one side of the film or simultaneously on the front and back side.

A particularly simple process for the single-side coating of a polymer film is that of drawing it through an immersion bath by means of a deflection roller. In this process, one side of the film is covered by the roller and only the other side is wetted by the polysilazane solution.

A further common process for film coating is application by means of one or more rollers. In this case, the polysilazane is applied to a roller which transfers the solution directly or indirectly to the polymer film.

The polysilazane coating is conditioned in a continuous drying process, either in an oven or by IR or NIR radiation. In addition, it is possible to subject the film, before, during or after the drying to an atmosphere with increased atmospheric moisture content. The atmospheric moisture content during this step is between 50 and 100% relative atmospheric humidity, preferably from 60 to 80% relative atmospheric humidity.

The drying process is effected in the course of a very short time, i.e. less than one minute, preferably fewer than 30 seconds.

Suitable selection of the drier temperatures or IR drier temperatures and belt speeds allows the polymer films based on polyolefins such as polyethylene, polypropylene, polyesters such as polyethylene terephthalate (PET), polyethylene naphthalate (PEN), polyamides, PVC, polycarbonate, PMMA or composed of copolymers of the polymer materials mentioned, to be dried in a simple manner, and the resulting film achieves good barrier values.

In particular, in the case of a PET film, suitable film speeds and appropriate radiator output allow curing of the polysilazane layer at temperatures between 50-100° C., in particular 80-90° C., within 10-120 seconds, in particular 20-30 seconds.

These short processing times make it possible to achieve high throughput by means of the dimensioning of the drying zone. In the case of a drying zone of length 10 m and a residence time of 60 seconds, it is possible, for example, to coat at a speed of 10 m/min. In the case of a doubling of the length of the zone to 20 m and a shorter residence time of only 15 seconds, it is possible, for example, to achieve 80 m/min. In the case of a further halving of the residence time, the speed is increased to 160 m/min.

The process of film coating can be repeated in order to apply a plurality of functional layers to the polymer film one on top of another.

The inventive polysilazane coating makes it possible to improve various performance-relevant properties of a polymer film. The layers obtained after curing, in very thin layer thicknesses, have very good protective action against oxygen, carbon dioxide or water vapor permeation.

Moreover, thicker layers can improve the scratch resistance of sensitive polymer films, for example on polycarbonate or PMMA. Furthermore, the chemical resistance of the films is significantly improved, for example of polycarbonate films which are very sensitive toward organic solvents.

Finally, addition of additives, for example nanoparticles, allows further properties of interest for application to be obtained, for example a UV-absorbing function by addition of finely divided zinc oxide or titanium dioxide.

The cured polysilazane coating typically has a layer thickness of form 0.02 to 10 micrometers, preferably from 0.1 to 5 micrometers, more preferably from 0.2 to 3 micrometers.

Suitable solvents for the polysilazane-based coating are particularly organic solvents which do not contain any water or any reactive groups (such as hydroxyl or amine groups). These are, for example, aliphatic or aromatic hydrocarbons, halo hydrocarbons, esters such as ethyl acetate or butyl acetate, ketones such as acetone or methyl ethyl ketone, ethers such as tetrahydrofuran or dibutyl ether, and also mono- and polyalkylene glycol dialkyl ethers (glymes) or mixtures of these solvents.

A further constituent of the polysilazane coating may be additives which influence, for example, viscosity of the formulation, substrate wetting, film formation or venting performance, or inorganic nanoparticles for example SiO₂, TiO₂, ZnO, ZrO₂ indium tin oxide (ITO) or Al₂O₃.

The catalysts used may, for example, be organic amines, acids or metals or metal salts, or mixtures of these compounds. The catalyst is used preferably in amounts of from 0.01 to 10%, in particular from 0.1 to 6%, based on the weight of the polysilazane.

Examples of amine catalysts are ammonia, methylamine, dimethylamine, trimethylamine, ethylamine, diethylamine, triethylamine, n-propylamine, isopropylamine, di-n-propylamine, di-isopropylamine, tri-n-propylamine, n-butylamine, isobutylamine di-n-butylamine, di-isobutylamine, tri-n-butylamine, n-pentylamine, di-n-pentylamine, tri-n-pentylamine, dicyclohexylamine, aniline, 2,4-dimethylpyridine, 4,4-trimethylenebis(1-methylpiperidine), 1,4-diazabicyclo[2.2.2]octane, N,N-dimethylpiperazine, cis-2,6-dimethylpiperazine, trans-2,5-dimethylpiperazine, 4,4-methylenebis(cyclohexylamine), stearylamine, 1,3-di-(4-piperidyl)propane, N,N-dimethylpropanolamine, N,N-dimethylhexanolamine, N,N-dimethyloctanolamine, N,N-diethylethanolamine, 1-piperidineethanol, 4-piperidinol. Examples of organic acids are acetic acid, propionic acid, butyric acid, valeric acid, caproic acid.

Examples of metals and metal compounds are palladium, palladium acetate, palladium acetylacetonate, palladium propionate, nickel, nickel acetylacetonate, silver powder, silver acetylacetonate, platinum, platinum acetylacetonate, ruthenium, ruthenium acetylacetonate, ruthenium carbonyls, gold, copper, copper acetylacetonate, aluminum acetylacetonate, aluminum tris(ethylacetoacetate).

Depending on the catalyst system used, the presence of moisture or of oxygen plays a role in the curing of the coating. Thus, selection of a suitable catalyst system allows rapid curing to be achieved at high or low atmospheric moisture content and at high or low oxygen content.

Before the application of the coating, it is possible first to apply a primer layer which may contribute to improvements in the adhesion of the polysilazane layer to the polymer film. Typical primers are those based on silane, for example 3-aminopropyl triethoxysilane, 3-glycidyloxypropyltriethoxysilane, 3-mercaptopropyltrimethoxysilane, vinyltriethoxysilane, 3-methacryloxypropyltrimethoxysilane, N-(2-aminoethyl)-3-aminopropyltrimethoxysilane, bis(3-triethoxysilylpropyl)amine, N-(n-butyl)-3-amino-propyltrimethoxysilane, N-(2-aminoethyl)-3-aminopropylmethyldimethoxysilane. It is also possible to pretreat the film in another way before coating, for example by flaming, corona treatment or plasma pretreatment.

In the same way, it is possible to use ready-preprimed films which have already been provided, in the course of production or thereafter, with a coating which improves the adhesion or wetting of the polysilazane solution.

The polymer films coated with polysilazane in accordance with the invention are likewise suitable for producing film composites. In this case, two or more films are combined to a composite material which has particular performance properties; this is of relevance for packaging films in particular.

### EXAMPLES

The perhydropolysilazanes used are products from Clariant Japan K.K. They are either solutions in xylene (denoted by NP) or di-n-butyl ether (denoted by NL). The solutions comprise amines, metals or metal salts as catalysts.

In the examples which follow, parts and percentages are based on the weight.

### Example 1 (Continuous Coating of a PET Film)

A PET film of thickness 23 micrometers is drawn at a speed of 3 m/min continuously by means of a deflection roller through an immersion bath which is filled with a mixture of a 20% perhydropolysilazane solution NP110-20 (Clariant Japan) which has been diluted with butyl acetate down to a concentration of 5%. In this process, only the front side of the film comes into contact with the perhydropolysilazane solution; the back side is covered by the deflection roller. Subsequently, the film is conducted through an infrared drying channel having a length of 60 cm. The residence time in the drying channel is thus approx. 12 seconds, this heats the film to a temperature of 60° C. The result is a clear and transparent film coated on one side.

The thickness of the coating is approx. 500 nm.

The oxygen permeability of a thus coated film is determined with a MOCON Oxtrans unit at 0% relative atmospheric humidity. The measured value is 14 ml/(d m² bar). In comparison thereto, an uncoated film has an oxygen permeability of 85 ml/(d m² bar).

### Example 2

A PET film of thickness 23 micrometers is drawn at a speed of 3 m/min continuously by means of a deflection roller through an immersion bath in which there is a 5% perhydropolysilazane solution [prepared from a 20% perhydropolysilazane solution NL120 A-20 (Clariant Japan) and dibutyl ether]. In this process, only the front side of the film comes into contact with the perhydropolysilazane solution; the back side is covered by the deflection roller. Subsequently, the film is conducted through an infrared drying channel having a length of 60 cm. The residence time in the drying channel is thus approx. 12 seconds; this heats the film to a temperature of 60° C. The result is a clear and transparent film coated on one side. The thickness of the coating is approx. 500 nm.

The oxygen permeability of a thus coated film is determined with a MOCON Oxtrans unit at 0% relative atmospheric humidity. The measured value is 12 ml/(d m² bar).

### Example 3 (Continuous Coating of a PET Film)

A PET film of thickness 23 micrometers, to which an SiOx layer had been applied beforehand under high vacuum, is drawn at a speed of 3 m/min continuously by means of a deflection roller through an immersion bath in which there is a 5% perhydropolysilazane solution [prepared from a 20% perhydropolysilazane solution NL120 A-20 (Clariant Japan) and dibutyl ether]. In this process, only the front side of the film comes into contact with the perhydropolysilazane solution; the back side is covered by the deflection roller. Subsequently, the film is conducted through an infrared drying channel having a length of 60 cm. The residence time in the drying channel is thus approx. 12 seconds; this heats the film to a temperature of 60° C. The result is a clear and transparent film coated on one side. The thickness of the coating is approx. 500 nm.

The oxygen permeability of a thus coated film is determined with a MOCON Oxtrans unit at 0% relative atmospheric humidity. The measured value is 1.0 ml/(d m² bar). In comparison thereto, a film which only has an SiOx layer applied under high vacuum exhibits an oxygen permeability of 2.5 ml/(d m² bar).

### Example 4

Analogous to 2, except with a reduced film speed, so as to result in a residence time of 20 seconds in the IR drying channel. This heats the film to a temperature of 80° C. The result is a clear and transparent film coated on one side. The thickness of the coating is approx. 500 nm.

The oxygen permeability of a thus coated film is determined with a MOCON Oxtrans unit at 0% relative atmospheric humidity. The measured value is 9 ml/(d m² bar).

### Example 5

Analogous to 2, except with a reduced film speed, so as to result in a residence time of 28 seconds in the IR drying channel. This heats the film to a temperature of 86° C. The result is a clear and transparent film coated on one side. The thickness of the coating is approx. 500 nm.

The oxygen permeability of a thus coated film is determined with a MOCON Oxtrans unit at 0% relative atmospheric humidity. The measured value is 7 ml/(d m² bar).

### Example 6

Analogous to 2, except with an increased film speed, so as to result in a residence time of 10 seconds in the IR drying channel. This heats the film to a temperature of 55° C. The result is a clear and transparent film coated on one side. The thickness of the coating is approx. 500 nm.

The oxygen permeability of a thus coated film is determined with a MOCON Oxtrans unit at 0% relative atmospheric humidity. The measured value is 20 ml/(d m² bar).

### Example 7

Analogous to 3, except with a reduced film speed, so as to result in a residence time of 22 seconds in the IR drying channel. This heats the film to a temperature of 82° C. The result is a clear and transparent film coated on one side. The thickness of the coating is approx. 500 nm.

The oxygen permeability of a thus coated film is determined with a MOCON Oxtrans unit at 0% relative atmospheric humidity. The measured value is 0.8 ml/(d m² bar).

1. A coating for a polymer film comprising a solution of a polysilazane or a mixture of polysilazanes of the formula 1
—(SiR′R″—NR′″)ₙ— (1)
where R′, R″, R″′ are the same or different and are each independently hydrogen or an optionally substituted alkyl, aryl or (trialkoxysilyl)alkyl radical, where n is an integer such that the polysilazane or the mixture of polysilazanes has a number-average molecular weight of from 150 to 150 000 g/mol, in at least one solvent and at least one catalyst, the solution of the polysilazane or the mixture of polysilazanes containing from 0.1 to 50% by weight of the polysilazane or mixture of polysilazanes and wherein the at least one solvent is anhydrous organic solvent which does not contain any reactive groups.

2. The coating as claimed in claim 1, wherein
R′, R″, R″′ are each independently a radical selected from the group of hydrogen, methyl, ethyl, propyl, isopropyl, butyl, isobutyl, tert-butyl, phenyl, vinyl of 3-(triethoxysilyl)propyl, and 3-(trimethoxysilyl)propyl.

3. The coating as claimed in claim 1 wherein the polysilazane or mixture of polysilazanes of the formula (1) is a perhydropolysilazane of the formula 2

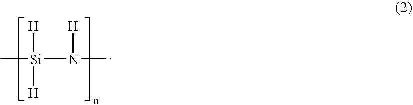

4. The coating as claimed in claim 1, wherein the polysilazane or mixture of polysilazanes of the formula (1) is a polysilazane of the formula (3)
—(SiR′R″—NR′″)ₙ—(SiR*R**—NR***)ₚ— (3)
where R′, R″, R″′, R*, R** and R*** are each independently hydrogen or an optionally substituted alkyl, aryl, vinyl or (trialkoxysilyl)alkyl radical where n and p are each an integer.

5. The coating as claimed in claim 4, wherein
R′, R″′ and R*** are each hydrogen, and R″, R* and R** are each methyl;

6. The coating as claimed in claim 1, wherein the polysilazane or mixture of polysilazanes of the formula (1) is a polysilazane of the formula (4)
—(SiR′R″—NR′″)ₙ—(SiR*R**—NR***)ₚ—(SiR¹, R²—NR³)_{q}— (4)
where R′, R″, R″′, R*, R**, R***, R¹, R² and R³ are each independently hydrogen or an optionally substituted alkyl, aryl, vinyl or (trialkoxysilyl)alkyl radical, where n, p and q are each an integer

7. The coating as claimed in claim 6, wherein R′, R″′ and R*** are each hydrogen, and R″, R*, R** and R² are each methyl, R³ is (triethoxysilyl)propyl and R¹ is alkyl or hydrogen.

8. The coating as claimed in claim 3, wherein the perhydropolysilazane solution contains from 0.01 to 10% by weight of the at least one catalyst.

9. The coating as claimed in claim 9, wherein the at least one catalyst is selected from the group consisting of organic amines, acids, metals, metal salts and mixtures thereof.

10. A process for continuously coating a film wherein the film has at least one surface, comprising the steps of applying a polysilazane or a mixture of polysilazanes of the formula (1)
—(SiR′R″—NR′″)ₙ— (1)
where R′, R″, R″′ are the same or different and are each either hydrogen or an optionally substituted alkyl, aryl or (trialkoxysilyl)alkyl radical, where n is an integer such that the polysilazane or mixture of polysilazanes has a number-average molecular weight of from 150 to 150 000 g/mol, in at least one solvent and at least one catalyst to the at least one surface of the film and drying the film by thermal treatment, IR or NIR radiation.

11. The process as claimed in claim 10, wherein the drying step is accomplished within a period of fewer than 60 seconds.

12. The process as claimed in claim 10, wherein the film is a polymer film.

13. A polymer film coated having at least one surface coated with a coating according to claim 1.

14. The polymer film as claimed in claim 13, wherein the polymer is a polyolefin, polyester, polyamide, polycarbonate, PMMA or PVC.

15. The polymer film as claimed in claim claim 13, wherein the coating has a coating thickness in the range from 0.02 to 10 micrometers.

16. A film composite comprising at least two polymer films, wherein the at least two polymer films are combined and wherein each polymer film of the at least two polymer films have at least one surface and wherein at least one surface of at least one of the at least two polymer films is coated with a coating according to claim 1.

17. The coating as claimed in claim 4, wherein R′, R″′ and R*** are each hydrogen, and R″, R* are each methyl, and R** is vinyl.

18. The coating as claimed in claim 4, wherein
R′, R″′, R* and R*** are each hydrogen, and R″ and R** are each methyl.

19. The coating as claimed in claim 1, wherein the at least one catalyst is selected from the group consisting of organic amines, acids, metals, metal salts and mixtures thereof.

20. The process as claimed in claim 10, wherein the drying step is accomplished within a period of fewer than 30 seconds.

21. A coated film coated in accordance with the process of claim 10.

22. The coated film as claimed in claim 21, wherein the film is a polymer film.

23. The coated film as claimed in claim 22, wherein the polymer is a polyolefin, polyester, polyamide, polycarbonate, PMMA or PVC.

24. The coated film as claimed in claim claim 21, wherein the coating has a coating thickness in the range from 0.02 to 10 micrometers.

25. The film composite as claimed in claim 16, wherein the at least two polymer films are selected from the group consisting of polyolefins, polyesters, polyamides, polycarbonates, PMMA and PVC.

26. A film composite comprising at least two polymer films, wherein the at least two polymer films are combined and wherein each polymer film of the at least two polymer films have at least one surface and wherein at least one surface of at least one of the at least two polymer films is coated in accordance with the process as claimed in claim 10.

27. The film composite as claimed in claim 25, wherein the at least two polymer films are selected from the group consisting of polyolefins, polyesters, polyamides, polycarbonates, PMMA and PVC.
